(19) United States
(12) Patent Application Publication
(10) Pub. No.: US 2011/0111940 A1
(43) Pub. Date: May 12, 2011

(54) DUNNAGE CONVERSION WITH YIELD-ENHANCED PAPER

(75) Inventor: Daniel L. Carlson, Ravenna, OH (US)

(73) Assignee: RANPAK CORP., Concord Township, OH (US)

(21) Appl. No.: 13/003,088

(22) PCT Filed: Jul. 9, 2009
(86) PCT No.: PCT/US2009/050097

§ 371 Date: Jan. 7, 2011

Related U.S. Application Data
(60) Provisional application No. 61/079,408, filed on Jul. 9, 2008.

(51) Int. Cl. B31B 1/26; B32B 29/00

(52) U.S. Cl. 493/405; 428/215; 428/535

(57) ABSTRACT

A method of converting a sheet stock material into a relatively less dense dunnage product includes the step of supplying the sheet stock material to a conversion mechanism for converting the sheet stock material into the dunnage product by permanently deforming the sheet stock material into a nonplanar configuration to provide the dunnage product with a density less than the density of the stock material from which it is formed. The sheet stock material comprises one or more plies of paper having a caliper no less than about 3.5 points (about 0.089 millimeter) or a bulk caliper no less than about 3.4 points (about 0.086 millimeter) for a basis weight no greater than about 32 pounds (about 86 grams per square meter) and when a moisture content is no greater than about 10%.

This application claims the benefit of U.S. Provisional Patent Application No. 61/079,408, filed Jul. 9, 2008, which is incorporated herein by reference.

### FIELD OF THE INVENTION

The present invention is related to conversion of a sheet stock material into a relatively lower density dunnage product, and more particularly to a method of converting a paper into a relatively less dense dunnage product, and an exemplary paper for conversion.

### BACKGROUND

Dunnage conversion machines convert a stock material into a dunnage product that can be used to pack articles and thus minimize or prevent damage during shipment. The dunnage conversion machines, also referred to as dunnage converters, include a conversion mechanism that converts a stock material into a relatively lower density dunnage product as the stock material moves through the conversion mechanism from an upstream end toward an outlet at a downstream end.

Paper is a sheet stock material that can be converted into a relatively lower density and relatively thicker dunnage product. Paper thickness is commonly measured in terms of “caliper.” The caliper of the paper is measured in fractions of a millimeter or inch by placing a single sheet under a steady pressure between parallel surfaces. Paper thickness can vary, however, so caliper also can be determined using a “bulk caliper” measurement. A bulk caliper measurement is taken of ten layers, for example, and the result is divided by ten to arrive at an average thickness. A typical thirty-pound basis weight (about 81 grams per square meter) kraft paper has a bulk caliper of about 0.0031 inch (about 0.079 millimeter). The thousandths-of-an-inch caliper measurement is sometimes referred to as “points,” so that in the above example the bulk caliper could be referred to as 3.1 thousandths of an inch or 3.1 points.

Paper typically has a moisture content of approximately 7%. Paper can change thickness if it absorbs additional moisture. The caliper measurements in the above example were taken at a moisture content of no more than 10%.

Toward the end of the paper-making process, the paper is fed through a series of polished rollers to produce a relatively smoother surface on the paper and to produce a paper with a more uniform thickness. This process is referred to as “calendaring.” Calendaring also tends to reduce the average thickness of the paper.

### SUMMARY

The present invention provides an improved method for producing a dunnage product by converting a flash-dried paper into a relatively thicker and less dense, dunnage product.

An exemplary method of converting a sheet stock material into a relatively less dense dunnage product includes the step of supplying the sheet stock material to a conversion mechanism for converting the sheet stock material into the dunnage product by permanently deforming the sheet stock material into a nonplanar configuration to provide the dunnage product with a density less than the density of the stock material from which it is formed. The sheet stock material comprises one or more plies of paper having a caliper no less than about 3.5 points or a bulk caliper no less than about 3.4 points (0.086 millimeter) for a basis weight no greater than about 32 pounds (about 86 grams per square meter) and when a moisture content is no greater than about 10%.

An exemplary sheet stock material comprises a plurality of superimposed plies of kraft paper, at least two plies having a caliper no less than 3.5 points or a bulk caliper no less than 4.0 points for a basis weight no greater than 32 pounds and when a moisture content is no greater than 10%. The sheet stock material preferably includes at least one ply of a non-calendared paper.

An exemplary sheet stock material for use with a conversion machine that converts the sheet stock material into a dunnage product includes a plurality of superimposed plies of kraft paper having a caliper no less than about 3.5 points or a bulk caliper no less than about 4.0 points for a basis weight no greater than 32 pounds and when a moisture content is no greater than about 10%.

Another exemplary sheet stock material for use with a conversion machine that converts the sheet stock material into a dunnage product includes a plurality of superimposed plies of kraft paper that was subjected to a flash drying process when it was made.

Finally, an exemplary sheet stock material for use in a conversion machine that converts the sheet stock material into a dunnage product includes a plurality of superimposed plies of a puffed paper provided by Bear Lake Fibre, LLC of Niles, Mich., U.S.

The foregoing and other features of the invention are hereinafter fully described and particularly pointed out in the claims, the following description and annexed drawings setting forth in detail certain illustrative embodiments of the invention, these embodiments being indicative, however, of but a few of the various ways in which the principles of the invention may be employed.

### BRIEF DESCRIPTION OF THE DRAWINGS

FIG. 1 is a schematic diagram of an exemplary dunnage conversion system for use with the present invention.

FIGS. 2-4 are schematic views of various types of supply of sheet stock material for use in the system of FIG. 1.

FIGS. 5-7 are side views of various types of dunnage conversion machines and their internal components, for use in the system of FIG. 1.

### DETAILED DESCRIPTION

The present invention provides a method of converting paper into a relatively thicker and less dense dunnage product. An exemplary paper is a yield-enhanced, flash-dried paper having a relatively thicker caliper and/or bulk caliper, a basis weight no greater than about 32 pounds (about 86 grams per square meter), and a moisture content of no greater than about 10% for conversion into a relatively less dense dunnage product.

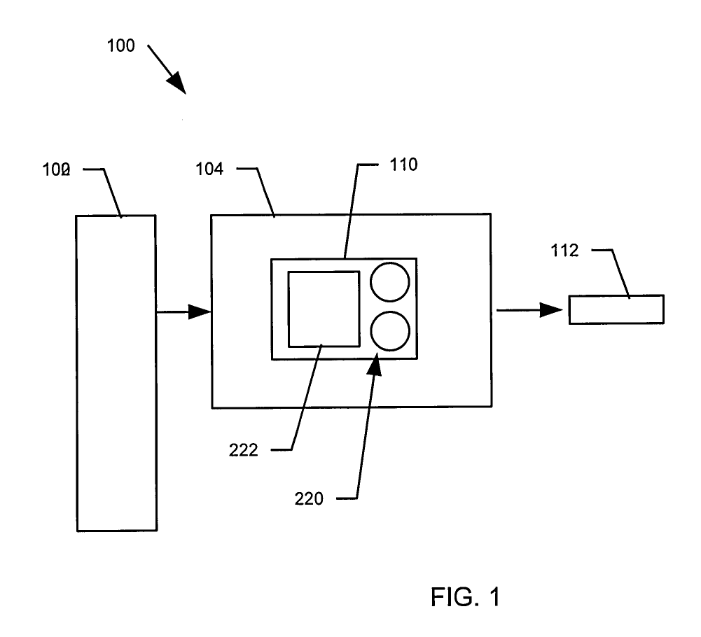

Referring now to the drawings in detail, and initially to FIG. 1, an exemplary dunnage conversion system 100 includes a supply of sheet stock material 102 upstream of a dunnage conversion machine 104. The dunnage conversion machine 104 includes a conversion mechanism 110 for converting the stock material 102 into a relatively thicker and less dense dunnage product 112.

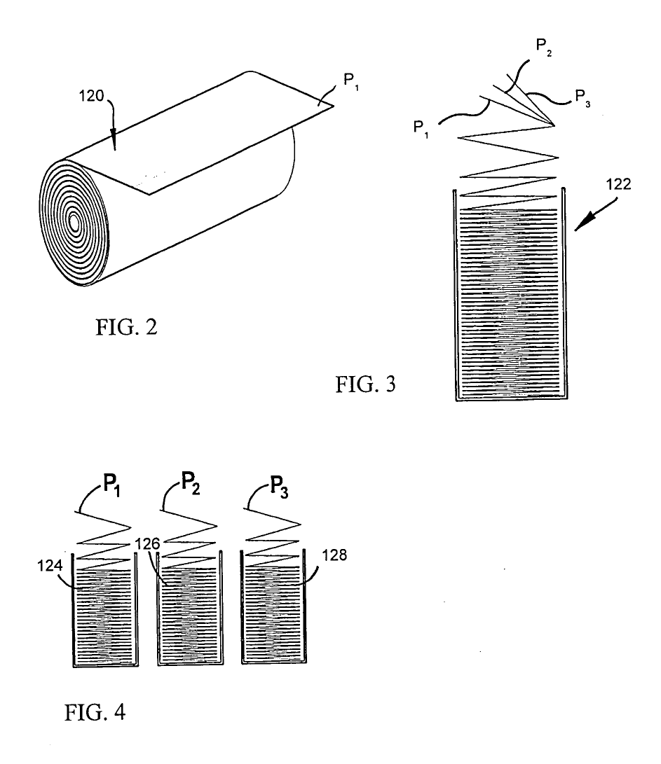

The sheet stock material typically is provided in the form of a continuous length wound to form a roll 120 or fan-folded in a stack 122 shown in FIGS. 2 and 3, respectively. In a fan-folded stack 122, the sheet stock material has a series of alternating folds that form a sequence of rectangular pages piled accordion-style one on top of another. Whether the supply is in roll or fan-folded form, either single-ply or multi-ply sheet material can be used. A single-ply roll 120 of stock material is shown in FIG. 2, while a multi-ply stack 122 is shown in FIG. 3 with three plies P1, P2, and P3. Alternatively, a multi-ply stock material may be supplied from multiple single-ply rolls or the stacks 124, 126 and 128 shown in FIG. 4, dispensing plies P1, P2, and P3, respectively.

In a roll of stock material, the stock material can be drawn from the outer surface of the roll, typically allowing the roll to rotate or turn as the stock material is drawn therefrom. Alternatively, the stock material can be drawn from the center of the roll.

The stock material provided by the present invention is paper, and particularly a flash-dried paper produced by Bear Lake Fibre, LLC of Niles, Mich., U.S. Flash drying typically occurs in a pre-drying stage of the paper-making process by rapidly heating a fiber slurry to remove the water. The rapid heating causes a violent expansion of the paper fibers that creates a puffed or fluffed web of paper that can be rolled or fan-folded for storage and shipment before being converted to a dunnage product. The paper preferably is not calendared, so that the paper is relatively thicker, has a less uniform thickness, and a rougher surface texture than a calendared paper.

The stock material may include different weights or thicknesses or combinations thereof, but generally the paper has a caliper of no less than 3.5 points (0.089 millimeter) or a bulk caliper of no less than 3.4 points (0.086 millimeter) for a basis weight no greater than 32 pounds (about 86 grams per square meter) and when a moisture content in the paper is no greater than about 10%. The paper has a basis weight of about 20 pounds (about 54 grams per square meter) to about 30 pounds (about 81 grams per square meter), and more particularly a basis weight of about 23 pounds (about 62 grams per square meter) to about 26 pounds (about 70 grams per square meter). The paper preferably includes 100% recycled paper fibers. This paper also is more porous and generally stronger than typical relatively-lower caliper kraft paper. Consequently, the dunnage product produced by the conversion process employing this paper also is expected to have a lower weight but greater strength compared to dunnage products produced by other types of stock material.

We compared a typical thirty-pound (about 81 grams per square meter) kraft paper, with a caliper of about 3.4 points (about 0.086 mm) and a bulk caliper of about 3.1 points (about 0.079 mm), to a relatively higher caliper kraft paper provided for conversion in the present invention. The high caliper kraft paper had a caliper of about 4.2 points (about 0.107 mm) and a bulk caliper of about 3.6 points (about 0.912 mm). The high caliper kraft paper provided a 23% increase in caliper and a 16% increase in bulk caliper. Other test results for comparing a relatively low caliper paper sample and a relatively high caliper paper sample are summarized in the following table.

TABLE 1
Test results for a low caliper paper sample and
a relatively higher flash-dried paper sample.

| Test | Low Caliper Paper | High Caliper Paper |
|---|---|---|
| Caliper | 3.4 pts. (0.086 mm) | 4.22 pts. (0.107 mm) |
| Bulk Caliper | 3.1 pts. (0.079 mm) | 3.59 pts (0.912 mm) |
| Moisture | 6.9% | 7.5% |
| Tear Strength in | 33.3 psi (2.30E5 Pa) | 38.3 psi (2.64E5 Pa) |
| Length Direction | | |
| Tear Strength Across | 45.0 psi (3.10E5 Pa) | 48.2 psi (3.32E5 Pa) |
| Length Direction | | |
| Tensile Strength in | 18.53 psi (1.28E5 Pa) | 17.83 psi (1.23E5 Pa) |
| Length Direction | | |
| Mullen Burst Strength | 21.1 psi (1.45E5 Pa) | 25.8 psi (1.78E5 Pa) |
| Gurley Porosity Test | 18.9 s | 7.9 s |
| Smoothness | 48.1 | 21.2 |
| Slide Angle in Length | 19.0 degrees | 20.3 degrees |
| Direction | | |
| Taber Stiffness in | 45 | 49 |
| Length Direction | | |

This relatively high caliper paper also provides a higher yield when converted to dunnage. In one instance the high caliper paper provided an approximately 33% increase in yield. Yield in the dunnage conversion context means that a greater amount of dunnage is produced for a given amount of stock material consumed in the process. The amounts can be measured as length and/or volume.

Many different types of conversion mechanism 110 (FIG. 1) can be used to convert the paper into a relatively less dense dunnage product. An exemplary conversion mechanism 110 includes a feed device 220 that draws the stock material through a crumpling device and/or forming device 222 (FIG. 1). The present invention proposes using the paper described above in a variety of different types of dunnage conversion machines.

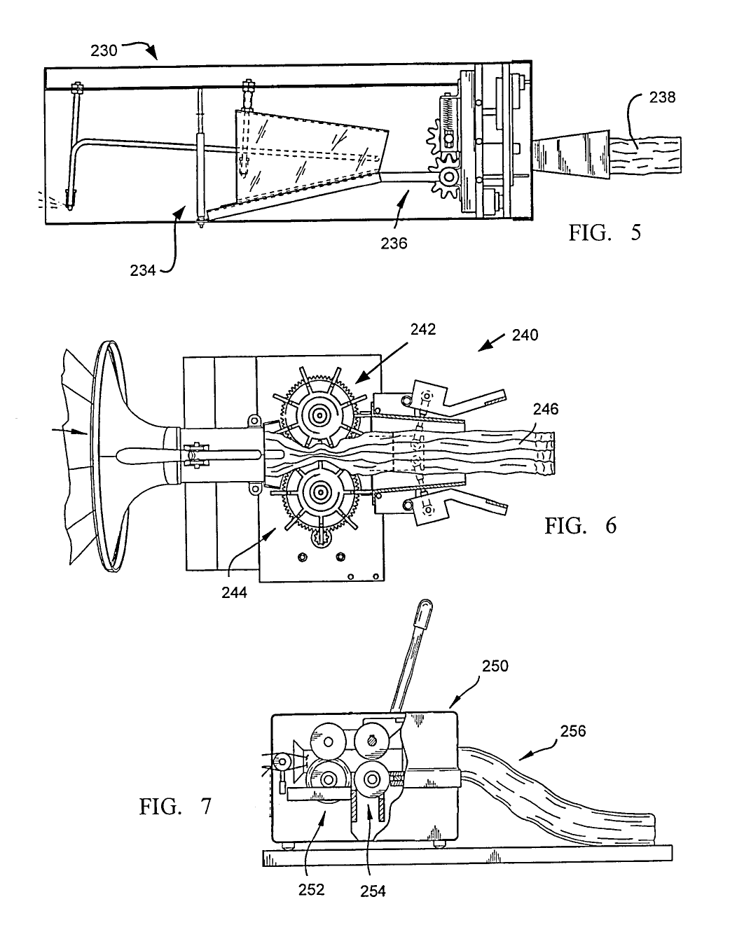

The dunnage conversion machine 230 shown in FIG. 5, for example, includes a conversion mechanism having a forming device 234 and a feed device 236 that feeds the stock material through the forming device 234. The forming device turns lateral edges of the sheet stock material inwardly and crumples the stock material as it is drawn therethrough. The feed device also connects overlapping layers of stock material to form a dunnage product 238 with lateral pillow portions spaced on either side of a connecting portion. In the connecting portion, the layers of stock material are held together, and therefore the connecting portion helps to maintain the shape of the dunnage product as it is manipulated.

Another dunnage conversion machine 240 is shown in FIG. 6. In this dunnage conversion machine a pair of grippers 242 and 244 form a combined feed device and crumpling device to laterally and transversely inwardly gather and crumple a sheet stock material as it moves through an aperture between the grippers 242 and 244. This conversion machine 240 produces another type of dunnage product 246, one which has undulating crumpled lobes and is suitable for use as a void fill dunnage product.

Still another type of conversion machine 250 is shown in FIG. 7. This dunnage conversion machine includes upstream and downstream sets of rotating members 252 and 254. The downstream rotating members 254 feed the stock material therethrough at a slower rate than the rate at which the stock material is fed by the upstream rotating members 252. As a result, the stock material accumulates and longitudinally crumples therebetween before being passed through the downstream rotating members 254. This type of dunnage conversion machine 250 produces a relatively flatter dunnage product 256 that can be used as a protective wrap or for layered protection.

Other types of conversion mechanisms or other means for converting the sheet stock material into a relatively thicker and/or less dense dunnage product can be used in place of the illustrated conversion machines 230, 240, and 250. For further details about dunnage conversion machines as shown or similar to the ones shown in FIGS. 25-27, reference may be had to U.S. Pat. Nos. 6,019,715; 6,277,459 and 6,676,589, each of which is hereby incorporated by reference.

An exemplary method of converting a sheet stock material into a relatively less dense dunnage product includes the step of supplying the sheet stock material to a conversion mechanism for converting the sheet stock material into the dunnage product by permanently deforming the sheet stock material into a nonplanar configuration to provide the dunnage product with a density less than the density of the stock material from which it is formed. The sheet stock material comprises one or more plies of paper having a caliper no less than about 3.5 points (about 0.089 millimeter) or a bulk caliper no less than about 3.4 points (about 0.086 millimeter) for a basis weight no greater than about 32 pounds (about 86 grams per square meter) and when a moisture content is no greater than about 10%.

An exemplary sheet stock material comprises a plurality of superimposed plies of kraft paper, at least two plies having a caliper no less than 3.5 points or a bulk caliper no less than 4.0 points for a basis weight no greater than 32 pounds and when a moisture content is no greater than 10%. The sheet stock material preferably includes at least one ply of a non-calendared paper.

An exemplary sheet stock material for use with a conversion machine that converts the sheet stock material into a dunnage product includes a plurality of superimposed plies of kraft paper having a caliper no less than about 3.5 points or a bulk caliper no less than about 4.0 points for a basis weight no greater than 32 pounds and when a moisture content is no greater than about 10%.

Another exemplary sheet stock material for use with a conversion machine that converts the sheet stock material into a dunnage product includes a plurality of superimposed plies of kraft paper that was subjected to a flash drying process when it was made.

Finally, an exemplary sheet stock material for use in a conversion machine that converts the sheet stock material into a dunnage product includes a plurality of superimposed plies of a puffed paper provided by Bear Lake Fibre, LLC of Niles, Mich., U.S.

Although the invention has been shown and described with respect to a certain illustrated embodiment or embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer which performs the specified function (i.e., that is functionally equivalent), even though not structurally equivalent to the disclosed structure which performs the function in the herein illustrated embodiment or embodiments of the invention.

1. A method of converting a sheet stock material into a relatively less dense dunnage product, comprising the step of supplying the sheet stock material to a conversion mechanism for converting the sheet stock material into the dunnage product by permanently deforming the sheet stock material into a nonplanar configuration to provide the dunnage product with a density less than the density of the stock material from which it is formed, wherein the sheet stock material comprises one or more plies of paper having a caliper no less than about 3.5 points (about 0.089 millimeter) or a bulk caliper no less than about 3.4 points (about 0.086 millimeter) for a basis weight no greater than about 32 pounds (about 86 grams per square meter) and when a moisture content is no greater than about 10%.

2. A method as set forth in claim 1, wherein the sheet stock material comprises a plurality of superimposed plies of kraft paper, at least two plies having a caliper no less than 3.5 points or a bulk caliper no less than 4.0 points for a basis weight no greater than 32 pounds and when a moisture content is no greater than 10%.

3. A method as set forth in claim 1, comprising severing the converted sheet stock material into sections.

4. A method as set forth in claim 1, wherein the sheet stock material includes at least one ply of a non-calendared paper.

5. A sheet stock material for use with a conversion machine that converts the sheet stock material into a dunnage product, the sheet stock material comprising a plurality of superimposed plies of kraft paper having a caliper no less than about 3.5 points or a bulk caliper no less than about 4.0 points for a basis weight no greater than 32 pounds and when a moisture content is no greater than about 10%.

6. A sheet stock material for use with a conversion machine that converts the sheet stock material into a dunnage product, the sheet stock material comprising a plurality of superimposed plies of kraft paper that was subjected to a flash drying process when it was made.

7. A sheet stock material for use in a conversion machine that converts the sheet stock material into a dunnage product, the sheet stock material comprising a plurality of superimposed plies of a puffed paper provided by Bear Lake Fibre, LLC of Niles, Mich., U.S.
